(19) United States
(12) Patent Application Publication
(10) Pub. No.: US 2011/0099865 A1
(43) Pub. Date: May 5, 2011

(54) Advertising Board for Vehicle and Apparatus for Fixing an Advertising Screen

(76) Inventor: Chang Mo Moon, Incheon (KR)

(21) Appl. No.: 12/938,560

(22) Filed: Nov. 3, 2010

(30) Foreign Application Priority Data
Nov. 4, 2009 (KR) 10-2009-0106158

(51) Int. Cl. G09F 21/04; G09F 17/00

(52) U.S. Cl. 40/591

(57) ABSTRACT

An advertising board for a vehicle and an apparatus for fixing an advertising screen, which can fix the advertising screen, attached to one side of the vehicle, in the condition that the advertising screen is spread with a desired tension. The advertising board for vehicle includes an advertising screen; a screen coupling part which is formed along edge sides of the advertising screen; a wall surface coupling part which is fixed to a wall surface of the vehicle; and tension means which pulls the screen coupling part toward the wall surface coupling part.

### CROSS-REFERENCE(S) TO RELATED APPLICATIONS

The present invention claims priority of Korean Patent Application No. 10-2009-0106158 filed on Nov. 4, 2009, which is incorporated herein by reference.

### BACKGROUND OF THE INVENTION

1. Field of the Invention

The present invention relates to an advertising board for vehicle; and, more particularly, to an advertising board for vehicle and an apparatus for fixing an advertising screen, which can fix the advertising screen, attached to one side of the vehicle, under the condition that the advertising screen is spread with a desired tension.

2. Description of Related Art

Generally, at one side or both sides of public transportation such as a bus, a car and a truck, there are provided advertising boards for attracting the attention of consumers who use the public transportation or who are passing by it, thereby obtaining high advertising effect at a low price.

In case of the advertising boards attached to various vehicles, because they are provided at moving vehicles, it is possible to obtain higher advertising effect than other advertising boards attached to fixed buildings.

Further, the advertising boards may be provided at the subway stations and the like that many people pass by so that advertisements are exposed to the people, thereby increasing the advertising effect.

However, the advertising board on which desired advertising design or copy is printed is simply attached to desired positions of the vehicle and the subway station. Thus, in case that the same advertising board having the same advertising contents is continuously provided for a long time period, the advertising effect is deteriorated, and thus it is inconvenient to frequently replace the advertising board with new one having new advertising contents.

In order to reduce a manufacturing cost of the advertising effect, the advertising board is typically formed into a screen shape formed of cloth or vinyl.

In case of the screen type advertising board, since it is facile to see the advertising contents when the advertising board is spread tightly at its installation position, it is necessary to fix the advertising board under the condition that the advertising board is spread tightly. However, it is very inconvenient to tightly spread the advertising screen which is frequently replaced, and thus it is necessary to easily spread the advertising screen tightly.

Moreover, in case of the advertising screen attached to the vehicle, if the advertising screen is fixed to the vehicle in the condition that the advertising screen is not spread tightly, the advertising screen may be damaged while the vehicle is run. Therefore, it is necessary for the advertising screen to be spread with a desired tension.

### SUMMARY OF THE INVENTION

An embodiment of the present invention is directed to providing an advertising board for vehicle and an apparatus for fixing an advertising screen, which can fix the advertising screen, attached to one side of the vehicle, in the condition that the advertising screen is spread with a desired tension.

To achieve the object of the present invention, the present invention provides an advertising board for vehicle, including an advertising screen; a screen coupling part which is formed along edge sides of the advertising screen; a wall surface coupling part which is fixed to a wall surface of the vehicle; and tension means which pulls the screen coupling part toward the wall surface coupling part, wherein the tension means comprises coupling of a bolt and a nut.

Preferably, the screen coupling part and the wall surface coupling part are fixedly coupled at an upper side of the wall surface of the vehicle, and the screen coupling part and the wall surface coupling part are tension-coupled at left, right and lower sides thereof.

Preferably, the tension means includes a wall surface fixing part which is fixed to the wall surface of the vehicle; a bolt which is coupled to the wall surface fixing part; a floating part of which one end is coupled with the bolt, and which is moved along the wall surface of the vehicle by rotation of the bolt; a nut which is coupled to the bolt and the end of the floating part, and is moved along the wall surface of the vehicle by rotation of the bolt so as to move the floating part; and a cutout member which is provided at an end of the screen coupling part, and coupled to the other end of the floating part so as to pull the advertising the screen according to the movement of the floating part.

Preferably, the wall surface fixing part further comprises a bolt fixing plate which has a desired space in which an E-ring is inserted so as to prevent the bolt from being separated.

Preferably, the wall surface fixing part further comprises a separation preventing plate which is extended in a moving direction of the floating part so as to be parallel with the wall surface of the vehicle in a desired distance, and the cutout member further comprises an extension part which is inserted inside the separation preventing plate when the advertising screen is pulled by movement of the floating part due to tightening of the bolt, thereby preventing the cutout member from being released from the other end of the floating part.

Preferably, the nut is formed into a polyhedral shape.

Preferably, the tension means includes a wall surface fixing part which is fixed to the wall surface of the vehicle; a bolt which is coupled to the wall surface fixing part; a nut which is coupled to the bolt; and a cutout member which is provided at an end of the screen coupling part, and coupled to the bolt and the nut so as to pull the advertising the screen according to tightening of the bolt.

Preferably, the wall surface fixing part further comprises a bolt fixing plate which has a desired space in which an E-ring is inserted so as to prevent the bolt from being separated.

Preferably, the nut is formed into a polyhedral shape.

Preferably, the screen fixing part which fixedly couples the screen coupling part and the wall surface coupling part at the upper side of the wall surface of the vehicle includes a cutout member having a cutout groove in which the screen coupling part is coupled; fixing means which fixes the cutout member to the wall surface of the vehicle; and a cover which is spaced apart from the wall surface of the vehicle in a distance and extended parallelly with the wall surface of the vehicle so as to cover the cutout member.

Preferably, the screen coupling part further comprises a plurality of cutout members which are spaced apart from each other along the wall surface of the vehicle at regular intervals so as to respectively have a different height from the wall surface of the vehicle in a vertical direction, and the cover is formed at the uppermost one out of the plurality of cutout members so as to cover all of the cutout members.

Further, the present invention provides an apparatus for fixing an advertising screen, which fixes the advertising screen to a wall surface of a vehicle, including a wall surface fixing part which is fixed to the wall surface of the vehicle; a bolt which is coupled to the wall surface fixing part; a floating part of which one end is coupled with the bolt, and which is moved along the wall surface of the vehicle by rotation of the bolt; a nut which is coupled to the bolt and the end of the floating part, and is moved along the wall surface of the vehicle by rotation of the bolt so as to move the floating part; and a cutout member which is provided at an end of the screen coupling part, and coupled to the other end of the floating part so as to pull the advertising the screen according to the movement of the floating part.

Preferably, the wall surface fixing part further comprises a bolt fixing plate which has a desired space in which an E-ring is inserted so as to prevent the bolt from being separated.

Preferably, the wall surface fixing part further comprises a separation preventing plate which is extended in a moving direction of the floating part so as to be parallel with the wall surface of the vehicle in a desired distance, and the cutout member further comprises an extension part which is inserted inside the separation preventing plate when the advertising screen is pulled by movement of the floating part due to tightening of the bolt, thereby preventing the cutout member from being released from the other end of the floating part.

Preferably, the nut is formed into a polyhedral shape.

Further, the present invention provides an apparatus for fixing an advertising screen, which fixes the advertising screen to a wall surface of a vehicle, including a wall surface fixing part which is fixed to the wall surface of the vehicle; a bolt which is coupled to the wall surface fixing part; a nut which is coupled to the bolt; and a cutout member which is provided at an end of the screen coupling part, and coupled to the bolt and the nut so as to pull the advertising the screen according to tightening of the bolt.

Preferably, the wall surface fixing part further comprises a bolt fixing plate which has a desired space in which an E-ring is inserted so as to prevent the bolt from being separated.

Preferably, the nut is formed into a polyhedral shape.

Further, the present invention provides an apparatus for fixing an advertising screen, which fixes the advertising screen to a wall surface of a vehicle, including a cutout member having a cutout groove in which the screen coupling part is coupled; fixing means which fixes the cutout member to the wall surface of the vehicle; and a cover which is spaced apart from the wall surface of the vehicle in a distance and extended parallelly with the wall surface of the vehicle so as to cover the cutout member.

Preferably, the cutout member is provided in plural which are spaced apart from each other along the wall surface of the vehicle at regular intervals so as to respectively have a different height from the wall surface of the vehicle in a vertical direction, and the cover is formed at the uppermost one out of the plurality of cutout members so as to cover all of the cutout members.

### BRIEF DESCRIPTION OF THE DRAWINGS

FIG. 1 is a schematic view showing an installation state of an advertising board according to the present invention.

FIG. 2 is a cross-sectional view showing a connection state between a screen coupling part and a first cutout member according to one embodiment of the present invention.

FIG. 3 is a cross-sectional view showing the connection state between the screen coupling part and the first cutout member according to other embodiment of the present invention.

FIG. 4 is an exploded perspective view of tension means according to a first embodiment of the present invention.

FIG. 5 is a cross-sectional view of the tension means according to the first embodiment of the present invention.

FIG. 6 is an exploded perspective view showing the connection state that a second cutout member and the tension means are connected with the screen coupling part according to a second embodiment of the present invention.

FIG. 7 is a cross-sectional view showing the connection state that the second cutout member and the tension means are connected with the screen coupling part according to the second embodiment of the present invention.

FIGS. 8 and 9 are a perspective view and a cross-sectional view showing an operation state of the tension means according to the second embodiment of the present invention.

FIG. 10 is an exploded perspective view showing the connection state that the second cutout member and the tension means are connected with the screen coupling part according to a third embodiment of the present invention.

FIGS. 11 and 12 are a perspective view and a cross-sectional view showing the connection state that the second cutout member and the tension means are connected with the screen coupling part according to the third embodiment of the present invention.

FIGS. 13 and 14 are a perspective view and a cross-sectional view showing an operation state of the tension means according to the third embodiment of the present invention.

### DETAILED DESCRIPTION OF MAIN ELEMENTS

| | |
|---|---|
| 1: | advertising board |
| 10: | advertising screen |
| 100: | main body |
| 200: | screen coupling part |
| 310: | wall surface coupling part |
| 400: | tension means |

### DESCRIPTION OF SPECIFIC EMBODIMENTS

The advantages, features and aspects of the invention will become apparent from the following description of the embodiments with reference to the accompanying drawings, which is set forth hereinafter.

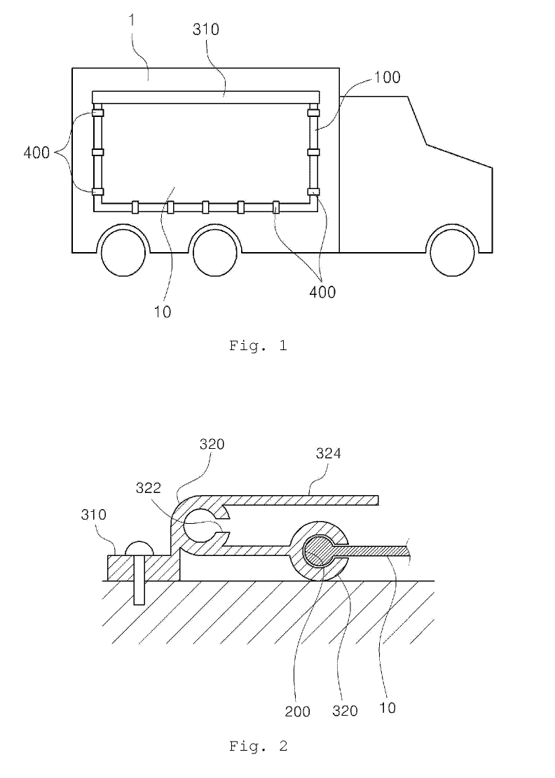

FIG. 1 is a schematic view showing an installation state of an advertising board 1 according to the present invention.

In the drawing, the advertising board is attached on a side surface of a vehicle. However, the advertising board may be also disposed at a public place like a subway station.

The advertising board 1 for vehicle according to the present invention includes a main body 100, a wall surface coupling part 310 which fixes one side of an advertising screen 10, and tension means which pulls the rest three sides of the advertising screen 10 with a desired tension and fixes them.

Construction elements of the wall surface coupling part 310 and the tension means 400 may be formed of aluminum having low weight and high strength.

The main body 100 may be disposed at a desired place where it is required to post an advertisement. The main body 100 is formed into a flat plate shape. A size of the main body 100 may be variously changed corresponding to a size of the vehicle on which the advertising board is disposed, or user's conditions. The main body 100 may be formed of various materials such as wood and metal, if it can keep the whole advertising board attached to a desired place.

Further, the main body 100 may be replaced with a surface of a wall or a side surface of a vehicle body, if construction elements of a fixing device to be described later and the advertising board can be fixed to it.

An advertising screen 10 is attached to a front surface of the main body 100. Advertising contents selected by a user are printed on a surface of the advertising screen 10. The advertising screen 10 may be formed of a flexible material such as cloth or a polyester film. Further, when the advertising screen 10 is not used, it may be kept in the form of a scroll, and it will be spread out when it is used.

Generally, the advertising screen 10 is formed into a rectangular shape, but if necessary, it may be formed into other shapes. In order to simplify the explanation and help the user's understanding, it is assumed that the advertising screen 10 is formed into the rectangular shape.

The wall surface coupling part 310 and the tension means 400 are respectively disposed along the four sides of the main body 100 in order to facilely fix, spread and keep the advertising screen 10. A first cutout member 320 is coupled to the wall surface coupling part 310.

The wall surface coupling part 310 is disposed along an upper side of the main body 100. Further, the tension means 400 is provided along the rest three sides of the main body 100 in plural which are spaced at regular intervals. In the drawing, three tension means 400 are provided at short sides of the advertising screen 10, and five tension means 400 are provided at long sides thereof. However, further more tension means 400 may be provided in order to keep the spread state of the advertising screen 10, and the installation interval may be also changed variously according to user's necessity.

Furthermore, only the tension means may be provided in plural at the four sides of the advertising screen 10. In this case, the tension means 400 are disposed at regular intervals and then coupled with a screen coupling part 200.

And in order to tightly spread the advertising screen 10 on the main body 100 and also maintain the spread state of the advertising screen 10, the screen coupling part 200 are provided along ends of the four sides of the advertising screen 10. As described later, the screen coupling part 200 is pulled by the tension means 400, and thus the as described later is also pulled with a desired tension.

Hereinafter, more detailed description will be provided.

### First Embodiment

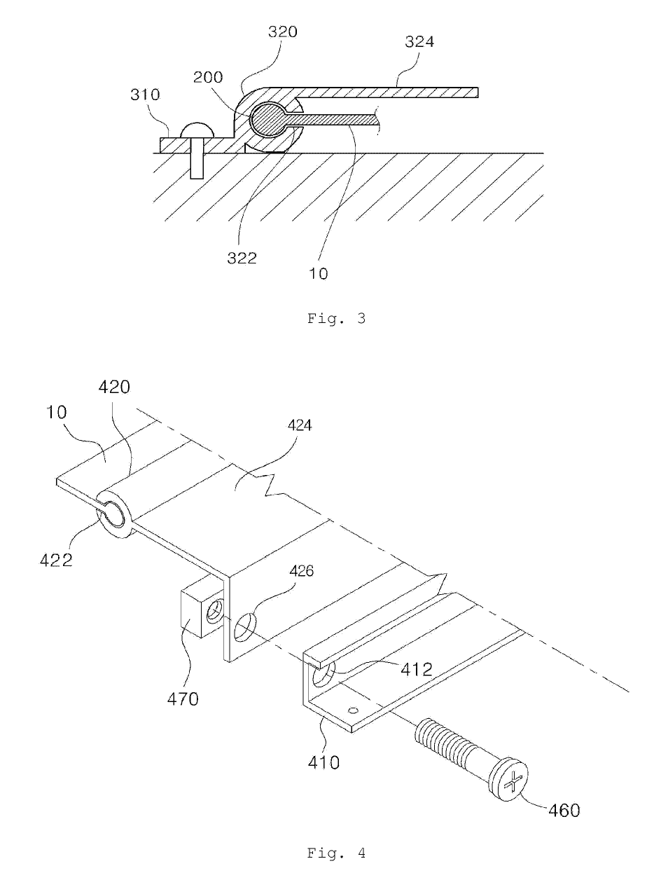

FIG. 2 is a cross-sectional view showing a connection state between the screen coupling part 200 and the first cutout member 320 according to a first embodiment of the present invention.

Referring to FIG. 2, the screen coupling part 200 is formed into a rod having a desired diameter. The screen coupling part 200 may be formed by rolling up an end of the advertising screen 10. Also, the screen coupling part 200 may be formed of other material, if it can be arranged together with the advertising screen 10 when folding or rolling up the advertising screen 10.

Preferably, the screen coupling part 200 is formed to have a larger diameter than a width of a first cutout groove 322 to be described later.

The wall surface coupling part 310 is provided at an upper side of the main body 100 so as to basically fix the advertising board 10, i.e., to fix one side of the advertising screen 10 at the upper side of the main body 100.

The wall surface coupling part 310 may include the first cutout member 320 and a first cover 324.

The wall surface coupling part 310 is fixedly installed at the upper long side of the main body 100. The wall surface coupling part 310 is fixed to the main body 100 by a bolt or a rivet. Further, the wall surface coupling part 310 may be welded to the main body 100 according to the material of the main body 100. Preferably, the wall surface coupling part 310 has an enough length to cover the whole upper side of the main body 100.

The first cutout member 320 is coupled to one side of the wall surface coupling part 310. The first cutout member 320 is formed into a tube shape and also formed with a first cutout groove 322 which is formed along one side of a circumferential surface thereof so as to have a desired width. The first cutout groove 322 is formed toward a central portion of the main body 100.

Preferably, the first cutout groove 322 has a larger width than a thickness of the advertising screen 10 so that the advertising screen 10 can be inserted through an end of the first cutout groove 322. However, the width of the first cutout groove 322 is smaller than a diameter of the screen coupling part 200.

Preferably, the first cutout groove 322 has an internal circumferential surface which is formed to be closely contacted with an outer circumferential surface of the screen coupling part 200 after the screen coupling part 200 is inserted therein.

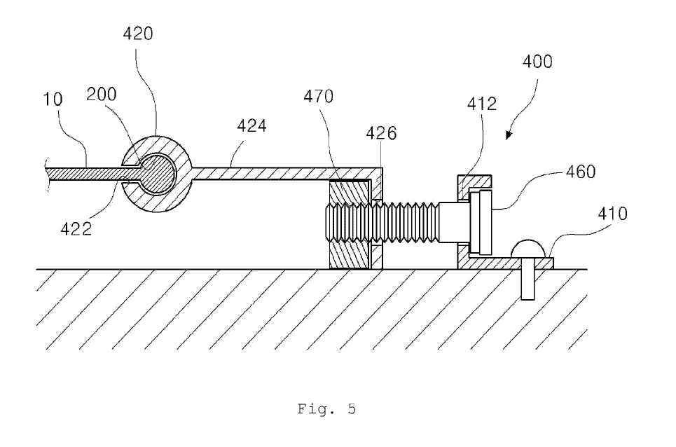

Referring to FIG. 2, the two first cutout members 320 are formed to have a different height, respectively. Two or more first cutout member 320 may be provided. Furthermore, as shown in FIG. 3, only a single first cutout member 320 may be provided. FIG. 3 is a cross-sectional view showing the connection state between the screen coupling part 200 and the first cutout member 320 according to other embodiment of the present invention.

Referring to FIG. 2, in case that the first cutout member 320 is provided in plural, the first cover 324 may be coupled in order to prevent the first cutout member 320 from being exposed to an outside. Herein, it is preferable that the first cover 324 is coupled to the first cutout member 320 which is positioned at the uppermost place.

Further, the first cover 324 is formed into a flat plate shape having a desired size that can cover the whole first cutout member 320. By the cover 324, the exterior of the wall surface coupling part 310 and the first cutout member 320 can be enhanced, and also it is prevented that the first cutout member 320 is damaged by external foreign substances.

Referring to FIG. 3, in case that only the single first cutout member 320 is formed, the first cover 324 is provided. However, in this case, the first cover 324 may be not provided.

FIG. 4 is an exploded perspective view of tension means 400 according to a first embodiment of the present invention, and FIG. 5 is a cross-sectional view of the tension means 400 according to the first embodiment of the present invention.

Referring to FIGS. 4 and 5, the tension means 400 may includes a wall surface fixing part 410, a second cutout member 420, a bolt 460 and a nut 470.

The wall surface fixing part 410 is fixed at the rest three sides of the main body 100, i.e., both short sides and lower long side of the main body 100, so as to be spaced apart at regular intervals. In the embodiment, the wall surface fixing part 410 may be formed into an ‘L’ shape. The wall surface fixing part 410 is fixed to the main body 100 by bolts and nuts. If necessary, the wall surface fixing part 410 may be permanently fixed to the main body 100 by welding.

The wall surface fixing part 410 is formed with a first bolt hole 412 which is horizontally formed to have a desired diameter and through which the bolt 460 is inserted. The first bolt hole 412 allows the bolt 460 to be inserted parallelly with regard to a front surface of the main body 100.

The second cutout member 420 is formed into a tube shape and also formed with a second cutout groove 422 which is formed along one side of a circumferential surface thereof so as to have a desired width. The second cutout groove 422 is formed toward an internal side of the advertising screen 10. Preferably, a width of the second cutout groove 422 is formed to be larger than the thickness of the advertising screen 10 but smaller than the diameter of the screen coupling part 200. The second cutout groove 422 has an internal circumferential surface which is formed to be closely contacted with the outer circumferential surface of the screen coupling part 200.

The second cutout member 420 is formed with a first connecting part 424 having a second bolt hole 426 through which the bolt 460 is inserted. The second cutout member 420 is connected with the screen coupling part 200 of the advertising screen 10.

The bolt 420 functions to adjust a distance between the wall surface fixing part 410 and the second cutout member 420. The nut 470 is coupled to an end of the bolt 460. After the bolt 460 is inserted into the first bolt hole 412 formed at the wall surface fixing part 410 of the tension means 400 and the end of the bolt 460 is inserted into the second bolt hole 426 of the first connecting part 424, the end of the bolt 460 is coupled with the nut 470. As the nut 470 is moved up and down by the adjustment of the bolt 460, the second cutout member 420 is also moved. If the second cutout member 420 is moved, the advertising screen 10 may be spread out, or relaxed in order to replace the advertising screen 10 with new one.

The nut 470 is formed into a polyhedral shape.

Hereinafter, the operation of the advertising board using the tension means according to the first embodiment of the present invention will be described.

First of all, the advertising screen 10 on which desired advertising contents are printed are prepared.

The screen coupling part formed at the upper long side out of the four sides of the advertising screen 10 is connected with the first cutout member 320.

Referring to FIG. 2, the screen coupling part 200 can be selectively inserted into one of the multiple first cutout members 320.

One end of the upper long side of the advertising screen 10 is inserted through an end of the first cutout groove 322 formed at the first cutout member 320. A basic position of the advertising screen 10 is set by positioning at an internal side of the wall surface coupling part 310 the screen coupling part 200 formed at the long side of the advertising screen 10. A plurality of wall surface fixing parts 410 are arranged on the wall along the three sides of the advertising screen 10. An arrangement interval of the wall surface fixing part 410 may be changed as occasion demands. Preferably, it is about 20-30 cm.

A user can adjust the bolt 460 using a screw driver. However, since the bolts 460 to be adjusted are too many, it is preferable to adjust the bolts 460 using a motor driver. If the bolt 460 is operated, the second cutout member 420 is moved to the wall surface fixing part 410 so as to pull the advertising screen 10, and thus the advertising screen 10 is spread tightly.

By adjusting the plurality of tension means 400 which are disposed at each side of the main body 100, as described above, the whole advertising screen 10 can be tightly spread, the spread state thereof can be also maintained, and thus customers can see clearly the advertising contents.

In case of replacing the advertisement, the advertising screen 10 is separated in a method which is operated in a reverse order of the method described above, and then new advertising screen is installed.

### Second Embodiment

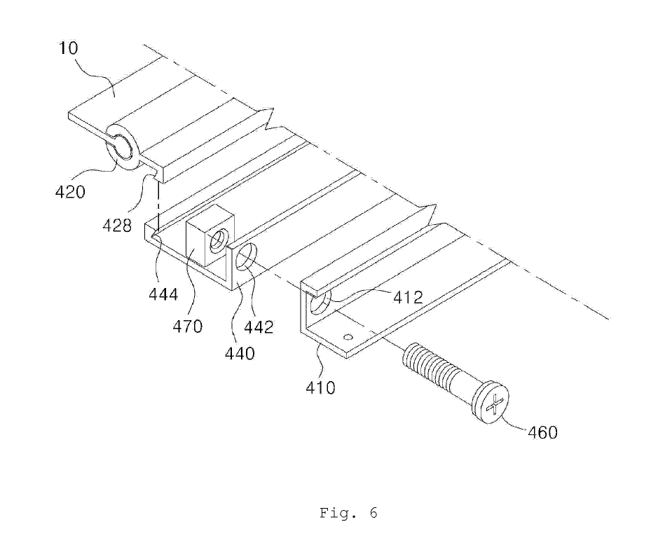

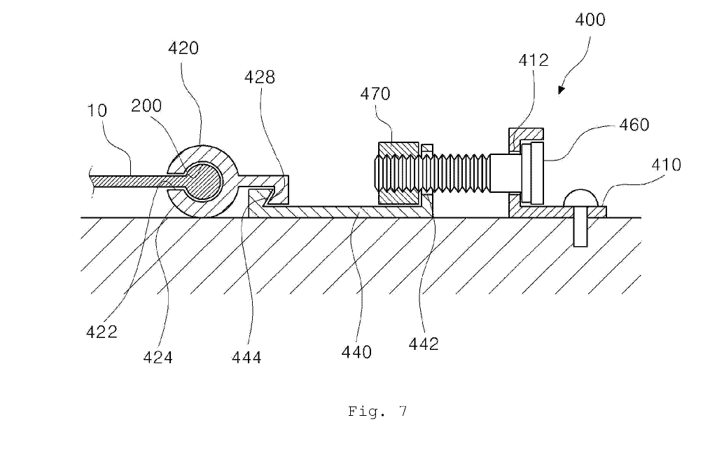

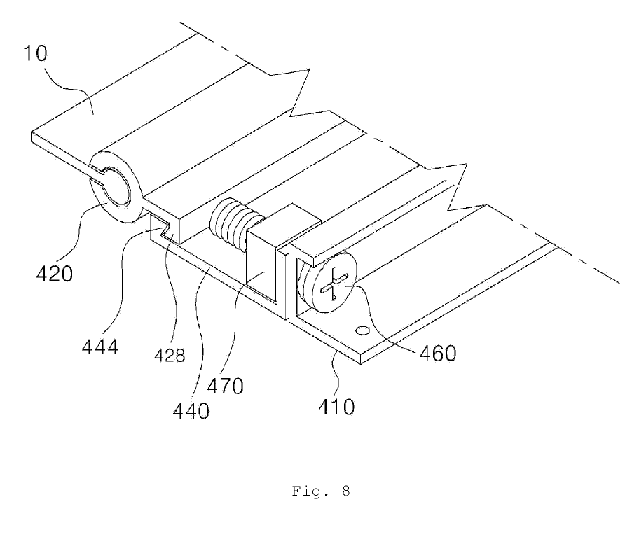

FIG. 6 is an exploded perspective view showing the connection state that a second cutout member 420 and the tension means 400 are connected with the screen coupling part 200 according to a second embodiment of the present invention, and FIG. 7 is a cross-sectional view showing the connection state that the second cutout member 420 and the tension means 400 are connected with the screen coupling part 200 according to the second embodiment of the present invention.

In the embodiment, one side of the advertising screen 10, i.e., the construction of the first cutout member 320 and the wall surface coupling part 310 fixed to the upper side of the main body 100 is the same as that in the first embodiment, and thus the detailed description thereof will be omitted.

In order to tightly spread the rest three sides of the advertising screen 10 of which one side is fixed by the wall surface coupling part 310, there is provided the tension means 400.

The tension means 400 is provided along the rest three sides of the advertising screen 10 in plural which are spaced at regular intervals.

Referring to FIGS. 6 and 7, the tension means 400 may includes the wall surface fixing part 410, the second cutout member 420, a floating part 440, the bolt 460 and the nut 470.

Since the tension means 400 of the embodiment has the same structure as in the first embodiment, except a floating part 440, the same parts as in the first embodiment are designated by the same numerical references as in the first embodiment, and also the detailed description thereof will be omitted. Therefore, only the additional parts will be described.

The second cutout member 420 may includes a first connecting hook 428 that is engaged with the floating part 440 to be described later.

The first connecting hook 428 is configured to be engaged with a second connecting hook 444 of the floating part 440. The first connecting hook 428 functions to transfer movement of the floating part 440 to the advertising screen 10 so that the advertising screen 10 is spread out.

The floating part 440 is moved by the adjustment of the bolt 460 so as to pull the second cutout member 420, thereby spreading the advertising screen 10 with a desired tension. One end of the floating part 440 is formed to be vertical, and the other end is formed to be horizontal, and the floating part 440 is formed into an ‘L’ shape.

At one end of the floating part 440, there is formed a bolt connecting hole 442 through which the end of the bolt 460 is inserted. At the other end of the floating part, there is formed the second connecting hook 444 engaged with the first connecting hook 428.

The bolt 460 functions to adjust the distance between the wall surface fixing part 410 and the floating part 440. The nut 470 is coupled to an end of the bolt 460. After the bolt 460 is inserted into the first bolt hole 412 formed at the wall surface fixing part 410 of the tension means 400 and the end of the bolt 460 is inserted into the bolt connecting hole 442 of the floating part 440, the end of the bolt 460 is coupled with the nut 470. As the nut 470 is moved up and down by the adjustment of the bolt 460, the second cutout member 420 is also moved. If the second cutout member 420 is moved by the movement of the floating part 440, the advertising screen 10 may be spread out, or relaxed in order to replace the advertising screen 10 with new one.

Hereinafter, the operation of the advertising board using the tension means according to the second embodiment of the present invention will be described.

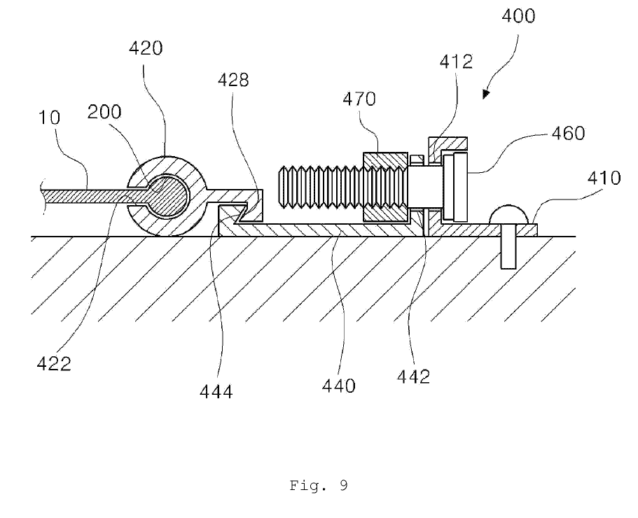

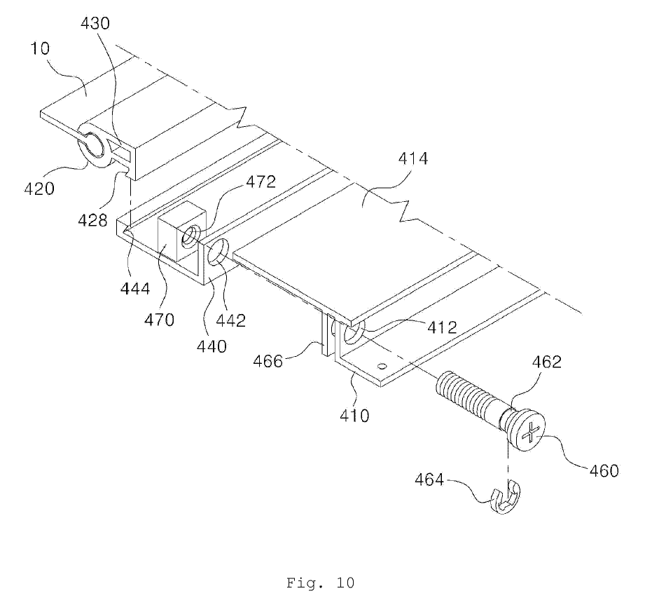

FIGS. 8 and 9 are a perspective view and a cross-sectional view showing an operation state of the tension means 400 according to the second embodiment of the present invention.

Referring to FIGS. 8 and 9, the floating part 440 moved to the wall surface coupling part 410 pulls the second cutout member 420 through the first and second connecting hooks 428 and 444. The pulled second cutout member 420 also pulls the advertising screen 10, thereby tightly spreading the advertising screen 10 with a desired tension.

By adjusting the plurality of tension means 400 which are disposed at each side of the main body 100, as described above, the whole advertising screen 10 can be tightly spread, the spread state thereof can be also maintained, and thus customers can see clearly the advertising contents.

In case of replacing the advertisement, the advertising screen 10 is separated in a method which is operated in a reverse order of the method described above, and then new advertising screen is installed.

### Third Embodiment

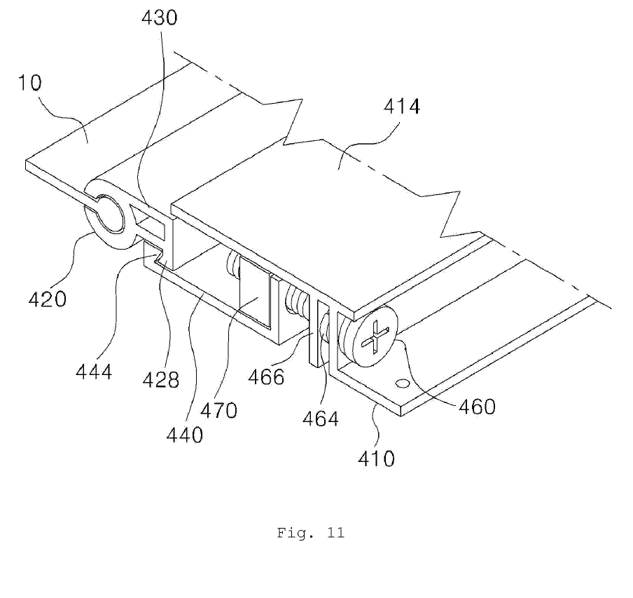

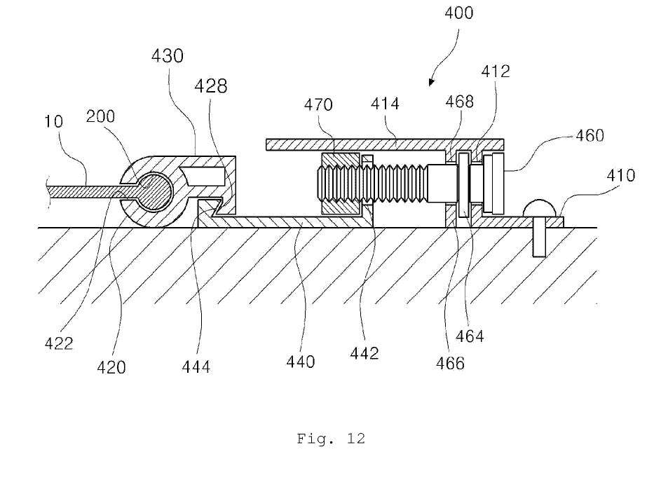

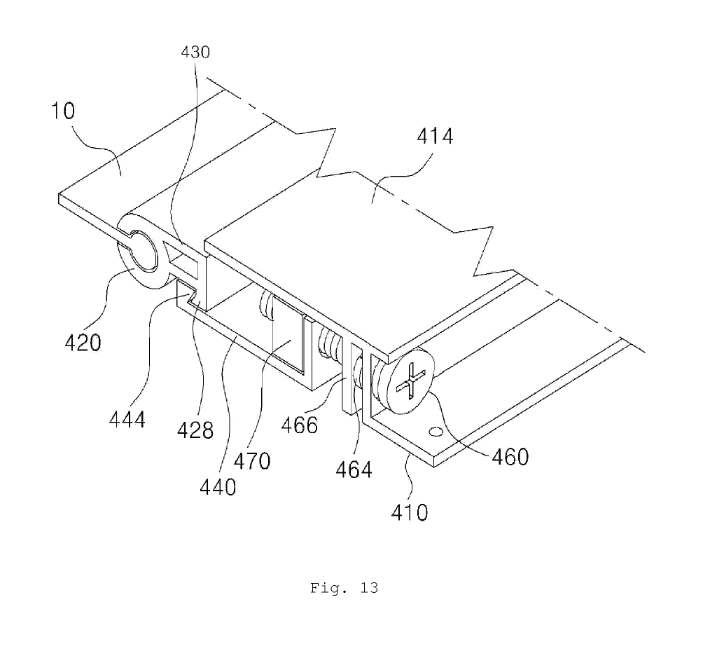

FIG. 10 is an exploded perspective view showing the connection state that the second cutout member 420 and the tension means 400 are connected with the screen coupling part 200 according to a third embodiment of the present invention, and FIGS. 11 and 12 are a perspective view and a cross-sectional view showing the connection state that the second cutout member 420 and the tension means 400 are connected with the screen coupling part 200 according to the third embodiment of the present invention.

In the embodiment, one side of the advertising screen 10, i.e., the construction of the first cutout member 320 and the wall surface coupling part 310 fixed to the upper side of the main body 100 is the same as that in the first embodiment, and thus the detailed description thereof will be omitted.

Also, the same parts in the second embodiment are designated by the same numerical references as in the second embodiment, and the detailed description thereof will be omitted.

Referring to FIGS. 10, 11 and 12, the tension means 400 may includes the wall surface fixing part 410, the second cutout member 420, a floating part 440, the bolt 460 and the nut 470.

The wall surface fixing part 410 may further include a separation preventing plate 414 and a bolt fixing plate 466.

Further, the second cutout member 420 may further include an extension part 430.

Further, the bolt 460 may further include an E-ring fixing groove 462 and an E-ring 464.

At an upper side of the wall surface fixing part 410, there is provided the separation preventing plate 414 having a desired surface area. The separation preventing plate 414 is disposed to be parallel with a vehicle body on which the advertising board is installed. The separation preventing plate 414 has an enough surface area to cover the first and second connecting hooks 428 and 444 which are engaged with each other, thereby preventing the engaged first and second connecting hooks 428 and 444 from being separated.

The separation preventing plate 414 is positioned at an upper side of the floating part 440 and the nut 470. When the floating part 440 is moved by the adjustment of the bolt 460, it is possible to prevent the nut 470 and the floating from being vibrated by external force.

Herein, since the nut 470 is formed into a hexahedral shaped, upper and lower portions of the nut 470 are closely contacted with the floating part 440 and the separation preventing plate 414, and thus it is prevented that the nut 470 is shaken, thereby maximizing the vibration preventing effect.

The second cutout member 420 is formed with the extension part 430 which is formed in a tangential direction of the second cutout member 420. The extension part 430 functions to provide a further strength to the second cutout member 420, thereby preventing damage of the second connecting hook 444 when the floating part 440 pulls the second cutout member 420 through the adjustment of the bolt 460 and also preventing the first and second connecting hooks 428 and 444 from being separated from each other due to the damage.

The E-ring 464 may be disposed at a center portion of the bolt 460. The E-ring 464 functions to prevent the bolt 460 from being vibrated upon the adjustment of the bolt 460. Preferably, the E-ring fixing groove 462 is formed at the center portion of the bolt 460 so that the E-ring 464 can be fastened to the E-ring fixing groove 462.

Preferably, the bolt fixing plate 466 is vertically formed at the wall surface fixing part 410 in order to enhance the vibration preventing effect of the bolt using the E-ring 464. The bolt fixing plate 466 is configured to be closely contacted with a rear surface of the E-ring 464. The bolt fixing plate 466 is formed with a bolt passing hole 468 through which the bolt 460 is passed.

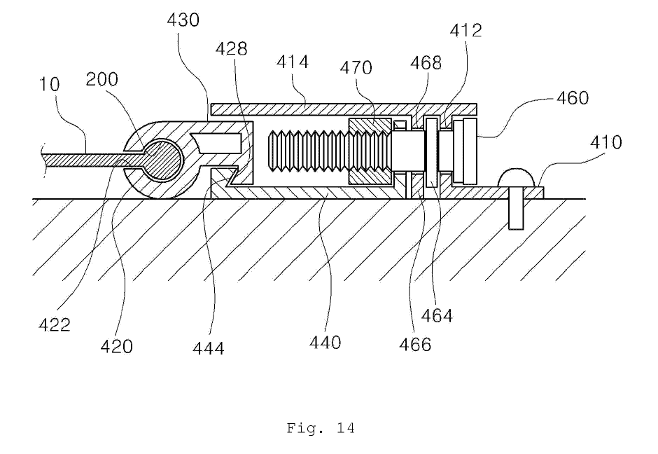

FIGS. 13 and 14 are a perspective view and a cross-sectional view showing an operation state of the tension means according to the third embodiment of he present invention.

In the embodiment, the second cutout member 420 is pulled by the adjustment of the bolt 460, and thus the advertising screen 10 can be pulled and spread by a desired tension.

Since the operation of the embodiment is the same as in the second embodiment, the description thereof will be omitted.

According to the present invention, it is possible to fix the advertising board in the condition that the advertising board is tightly spread.

In addition, since the advertising board attached to the vehicle is tightly spread with a desired tension, it is prevented that the advertising board is damaged while the vehicle is run.

While the present invention has been described with respect to the specific embodiments, it will be apparent to those skilled in the art that various changes and modifications may be made without departing from the spirit and scope of the invention as defined in the following claims.

What is claimed is:

1. An advertising board for vehicle, comprising:
an advertising screen;
a screen coupling part which is formed along edge sides of the advertising screen;
a wall surface coupling part which is fixed to a wall surface of the vehicle; and
tension means which pulls the screen coupling part toward the wall surface coupling part,
wherein the tension means comprises a coupling of a bolt and a nut.

2. The advertising board of claim 1, wherein the screen coupling part and the wall surface coupling part are fixedly coupled at an upper side of the wall surface of the vehicle, and the screen coupling part and the wall surface coupling part are tension-coupled at left, right and lower sides thereof.

3. The advertising board of claim 2, wherein the tension means comprises:
a wall surface fixing part which is fixed to the wall surface of the vehicle;
a bolt which is coupled to the wall surface fixing part;
a floating part of which one end is coupled with the bolt, and which is moved along the wall surface of the vehicle by rotation of the bolt;
a nut which is coupled to the bolt and the end of the floating part, and is moved along the wall surface of the vehicle by rotation of the bolt so as to move the floating part; and
a cutout member which is provided at an end of the screen coupling part, and coupled to the other end of the floating part so as to pull the advertising the screen according to the movement of the floating part.

4. The advertising board of claim 3, wherein the wall surface fixing part further comprises a bolt fixing plate which has a desired space in which an E-ring is inserted so as to prevent the bolt from being separated.

5. The advertising board of claim 3, wherein the wall surface fixing part further comprises a separation preventing plate which is extended in a moving direction of the floating part so as to be parallel with the wall surface of the vehicle in a desired distance, and
the cutout member further comprises an extension part which is inserted inside the separation preventing plate when the advertising screen is pulled by movement of the floating part due to tightening of the bolt, thereby preventing the cutout member from being released from the other end of the floating part.

6. The advertising board of claim 3, wherein the nut is formed into a polyhedral shape.

7. The advertising board of claim 2, wherein the tension means comprises:
a wall surface fixing part which is fixed to the wall surface of the vehicle;
a bolt which is coupled to the wall surface fixing part;
a nut which is coupled to the bolt; and
a cutout member which is provided at an end of the screen coupling part, and coupled to the bolt and the nut so as to pull the advertising the screen according to tightening of the bolt.

8. The advertising board of claim 7, wherein the wall surface fixing part further comprises a bolt fixing plate which has a desired space in which an E-ring is inserted so as to prevent the bolt from being separated.

9. The advertising board of claim 7, wherein the nut is formed into a polyhedral shape.

10. The advertising board of claim 2, wherein the screen fixing part which fixedly couples the screen coupling part and the wall surface coupling part at the upper side of the wall surface of the vehicle comprises:
a cutout member having a cutout groove in which the screen coupling part is coupled;
fixing means which fixes the cutout member to the wall surface of the vehicle; and
a cover which is spaced apart from the wall surface of the vehicle in a distance and extended parallelly with the wall surface of the vehicle so as to cover the cutout member.

11. The advertising board of claim 10, wherein the screen coupling part further comprises a plurality of cutout members which are spaced apart from each other along the wall surface of the vehicle at regular intervals so as to respectively have a different height from the wall surface of the vehicle in a vertical direction, and
the cover is formed at the uppermost one out of the plurality of cutout members so as to cover all of the cutout members.

12. An apparatus for fixing an advertising screen, which fixes the advertising screen to a wall surface of a vehicle, comprising:
a wall surface fixing part which is fixed to the wall surface of the vehicle;
a bolt which is coupled to the wall surface fixing part;
a floating part of which one end is coupled with the bolt, and which is moved along the wall surface of the vehicle by rotation of the bolt;
a nut which is coupled to the bolt and the end of the floating part, and is moved along the wall surface of the vehicle by rotation of the bolt so as to move the floating part; and
a cutout member which is provided at an end of the screen coupling part, and coupled to the other end of the floating part so as to pull the advertising the screen according to the movement of the floating part.

13. The apparatus of claim 12, wherein the wall surface fixing part further comprises a bolt fixing plate which has a desired space in which an E-ring is inserted so as to prevent the bolt from being separated.

14. The apparatus of claim 12, wherein the wall surface fixing part further comprises a separation preventing plate which is extended in a moving direction of the floating part so as to be parallel with the wall surface of the vehicle in a desired distance, and
the cutout member further comprises an extension part which is inserted inside the separation preventing plate when the advertising screen is pulled by movement of the floating part due to tightening of the bolt, thereby preventing the cutout member from being released from the other end of the floating part.

15. The apparatus of claim 14, wherein the nut is formed into a polyhedral shape.

16. An apparatus for fixing an advertising screen, which fixes the advertising screen to a wall surface of a vehicle, comprising:
a wall surface fixing part which is fixed to the wall surface of the vehicle;
a bolt which is coupled to the wall surface fixing part;
a nut which is coupled to the bolt; and
a cutout member which is provided at an end of the screen coupling part, and coupled to the bolt and the nut so as to pull the advertising the screen according to tightening of the bolt.

17. The apparatus of claim 14, wherein the wall surface fixing part further comprises a bolt fixing plate which has a desired space in which an E-ring is inserted so as to prevent the bolt from being separated.

18. The apparatus of claim 14, wherein the nut is formed into a polyhedral shape.

19. An apparatus for fixing an advertising screen, which fixes the advertising screen to a wall surface of a vehicle, comprising:
a cutout member having a cutout groove in which the screen coupling part is coupled;
fixing means which fixes the cutout member to the wall surface of the vehicle; and
a cover which is spaced apart from the wall surface of the vehicle in a distance and extended parallelly with the wall surface of the vehicle so as to cover the cutout member.

20. The apparatus of claim 14, wherein the cutout member is provided in plural which are spaced apart from each other along the wall surface of the vehicle at regular intervals so as to respectively have a different height from the wall surface of the vehicle in a vertical direction, and
the cover is formed at the uppermost one out of the plurality of cutout members so as to cover all of the cutout members.
